(19) United States
(12) Patent Application Publication
(10) Pub. No.: US 2026/0352134 A1
(43) Pub. Date: Nov. 5, 2026

(54) POWER DEVICE CONTROL AT LOW MOTOR SPEED OPERATION IN PROPULSION DRIVE CONVERTER

(71) Applicant: FORD GLOBAL TECHNOLOGIES, LLC, Dearborn, MI (US)

(72) Inventors: Jogendra Singh Thongam, Windsor (CA); Baoming Ge, Okemos, MI (US); Ji Wu, Ann Arbor, MI (US); Steven Bradford, Trenton, MI (US); Kevin Lloyd Newman, Farmington Hills, MI (US); Milind B. Kulkarni, Livonia, MI (US)

(21) Appl. No.: 19/197,624

(22) Filed: May 2, 2025

(51) Int. Cl. H02P 27/08; B60L 15/20

(52) U.S. Cl. CPC H02P 27/085; B60L 15/20

(57) ABSTRACT

A power electronics system for vehicle propulsion includes an electric machine, a multi-phase inverter or power converter, and a temperature-based mechanism for the inverter's switches. During rotor lock or operation at a constant multi-phase current—such as 1 Hz—the system selectively halts pulse width modulation commands to the switches at specific rotor positions, either at or away from peak current values, to manage thermal stress. The system may also reduce power output based on switch temperature.

### TECHNICAL FIELD

This disclosure relates to power electronics systems.

### BACKGROUND

Operation of an inverter may generate heat.

### SUMMARY

A power electronics system includes an electric machine, a multi-phase inverter with multiple switches, and a controller that shuts down the inverter based on the instantaneous temperature of one of the switches during rotor lock or low speed. The controller may also reduce the inverter's power output depending on this temperature. Shutdown can occur at specific rotor positions, such as those corresponding to peak, negative peak, or non-peak phase current values. Because the switches do not have built-in temperature sensors, the system may instead use a temperature sensor mounted near one of the switches to monitor thermal conditions.

A vehicle propulsion drive system includes a traction battery, an electric machine, and a power converter that transfers power between the battery and the electric machine. During operation at a constant multi-phase current—such as a constant 1 Hz current—the system stops pulse width modulation commands to the power converter's switches at regular intervals of one electric revolution of the rotor, but not at peak or negative peak current values. In some cases, the system may instead stop modulation at those peak or negative peak values. The system may also reduce the power converter's output under certain conditions. Because the switches lack integrated temperature sensors, a temperature sensor may be positioned adjacent to one of the switches.

An automotive control system operates a multi-phase inverter at a constant multi-phase current, such as a constant 1 Hz current, and stops pulse width modulation commands to the inverter's switches at peak or negative peak values of the current. In some instances, the system may instead stop modulation at regular intervals during each electric revolution of the rotor that do not align with those peak or negative peak values. The system can also reduce the inverter's power output under certain conditions. Because the switches lack built-in temperature sensors, a separate temperature sensor may be installed adjacent to a switch.

### BRIEF DESCRIPTION OF THE DRAWINGS

FIG. 1 is a schematic diagram of a vehicle power system.

FIG. 2 is a block diagram of a junction temperature estimation strategy.

FIG. 3 is a block diagram of a silicon carbide chip and direct bonded copper temperature sensor.

FIGS. 4A and 4B are power switch conduction loss and switching loss models, respectively.

FIG. 5 are plots of direct bonded copper and junction temperature difference.

FIG. 6 is a flow chart of an inverter control algorithm.

FIG. 7 are plots of simulated conduction loss.

FIG. 8 are plots of simulated switching loss.

FIG. 9 are plots of simulated power loss.

FIG. 10 are plots of simulated instantaneous power loss and power device temperature during a start-up operation.

FIG. 11 are plots of simulated instantaneous and average junction temperatures.

FIG. 12 is a block diagram of a test setup.

FIGS. 13-15 are plots of phase current versus rotor position.

### DETAILED DESCRIPTION

Embodiments are described herein. These embodiments, however, are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Monitoring the temperature of power devices in an electric vehicle (EV) propulsion drive converter allows operation within the system's maximum power envelope. In conventional EV propulsion drive converters, silicon insulated-gate bipolar transistors (Si-IGBTs) are commonly equipped with on-die temperature sensors that provide real-time monitoring and enable over-temperature protection.

Silicon carbide (SiC) MOSFETs have been adopted for power converters in electric drives due to their lower power losses, higher switching speeds, greater voltage handling capabilities, and higher allowable junction temperatures compared to Si-IGBTs. However, current technology trends focus on reducing chip size and integrating an on-die temperature sensor in SiC MOSFETs can be challenging. As a result, these devices do not include junction temperature sensors, making over-temperature protection more difficult to implement.

Junction temperature estimation methods are used to monitor SiC MOSFET temperatures, relying on power loss calculations to infer the junction temperature. Existing power loss computation techniques are designed for high-speed motor operation, where losses are estimated using the root mean square (RMS) current as an input. This approach is less (or not) effective at low motor speeds because the inverter's output current has a long fundamental period, leading to power losses. Under these conditions, the six power switches in the converter experience different junction temperatures, which RMS current-based loss estimations do not accurately represent. As a result, the computed junction temperature does not correspond to the actual device temperature.

Si-IGBTs equipped with on-die temperature sensors can execute over-temperature protection during low-speed motor operation by directly monitoring instantaneous device temperature. In contrast, SiC MOSFETs lack on-die temperature sensors, requiring junction temperature estimation methods for monitoring. These methods perform effectively at high motor speeds, where inverter switch losses can be periodically calculated within the fundamental cycle.

At low motor speeds, the existing method is less effective because the inverter's output current has a long fundamental period. Losses calculated over the full period do not accurately reflect the instantaneous losses of individual devices, limiting power switch protection. In practice, the six inverter switches experience different instantaneous power losses, with some switches operating under higher thermal stress than others. The locked rotor condition represents an extreme case where loss distribution is highly unbalanced. Since the existing loss and junction temperature estimation methods rely on RMS current-based calculations, they do not capture thermal conditions accurately during low-speed operation, reducing the effectiveness of over-temperature protection.

The proposed techniques provide over-temperature protection for SiC power devices in low-speed motor operation without the need for on-die temperature sensors. This approach enables the computation and estimation of instantaneous power losses and junction temperatures for each individual power device in the power converter. By allowing over-temperature detection under low fundamental frequency and imbalanced phase operation, the techniques address limitations present in conventional RMS current-based loss estimation techniques.

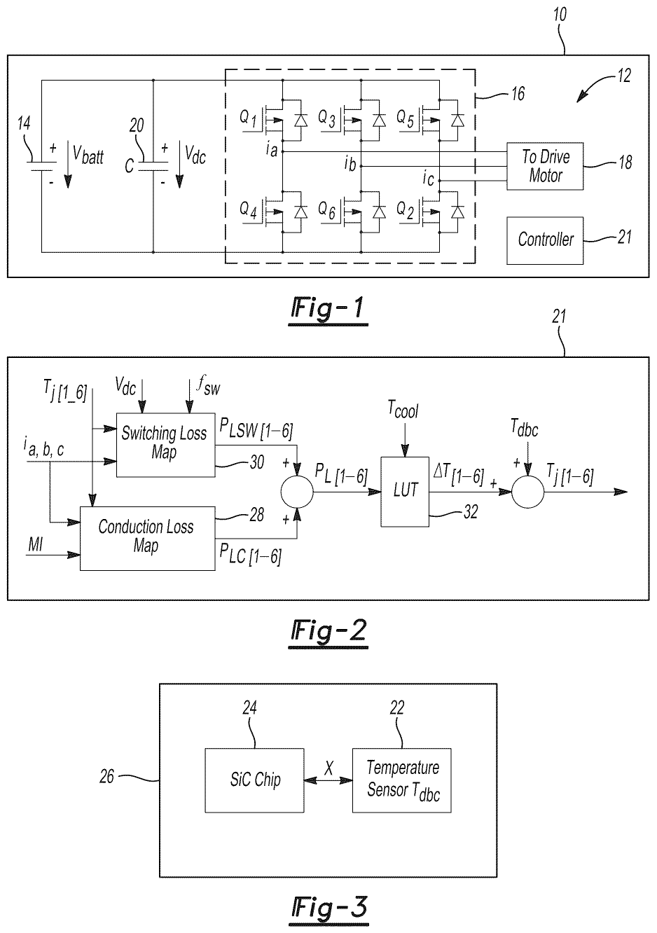

The schematic diagram of FIG. 1 represents an electric vehicle (EV) 10 and its propulsion drive system 12, where a traction battery 14 batt supplies power to a SiC MOSFET-based power converter 16, which in turn drives an electric V machine 18, a three-phase propulsion motor. The traction battery 14 provides DC voltage, which is stabilized by a DC link capacitor 20 C. This capacitor helps maintain a steady DC bus voltage Vdc by filtering fluctuations and supplying transient power during switching events.

The power conversion is carried out by the three-phase inverter 16, including six SiC MOSFETs Q1 to Q6, which convert the DC voltage into a three-phase AC output under the direction of controller 21. The MOSFETs operate in a complementary switching manner, generating pulse-width modulated (PWM) signals to manage motor torque and speed. Each MOSFET is paired with a body diode, which allows freewheeling of current when the corresponding switch is off, preventing abrupt voltage spikes. The inverter 16 outputs three-phase currents ia, ib, ic, which are supplied to the propulsion drive motor 18. This motor converts the electrical energy into mechanical motion, driving the vehicle 10.

The power devices are controlled through their respective gate drive circuits and generate heat during converter operation. This heat is dissipated through a coolant loop to manage the power device temperature within a specified range. If the junction temperature of a power device exceeds a predefined threshold, a motor torque derating control mechanism is activated to reduce thermal stress.

Under high-speed operation of the propulsion drive motor 18, junction temperature can be estimated using power loss calculations, with RMS current as one of the key inputs. However, during low-speed operation, the inverter output current has a long fundamental period, making RMS current-based loss computations ineffective in representing actual device losses as mentioned above.

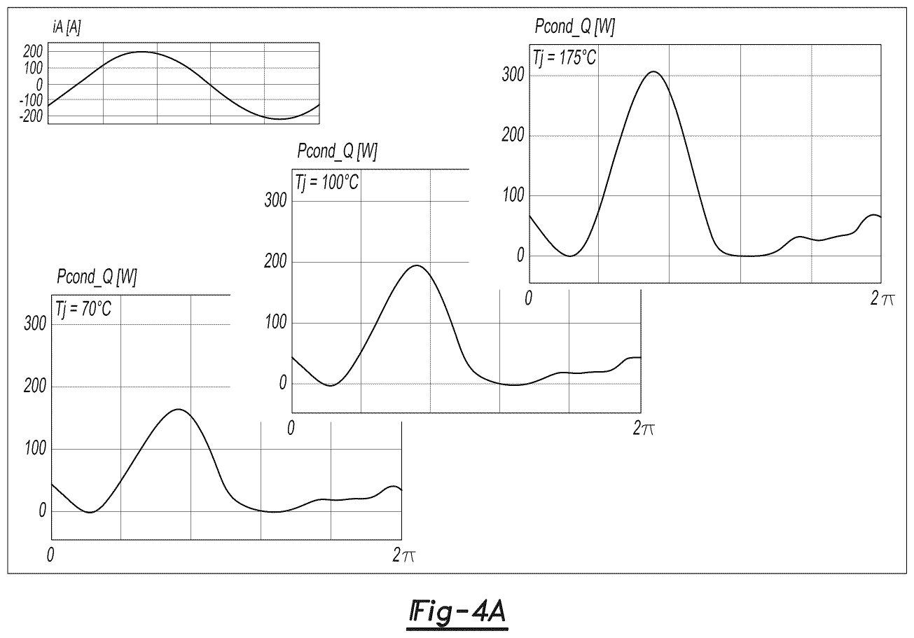

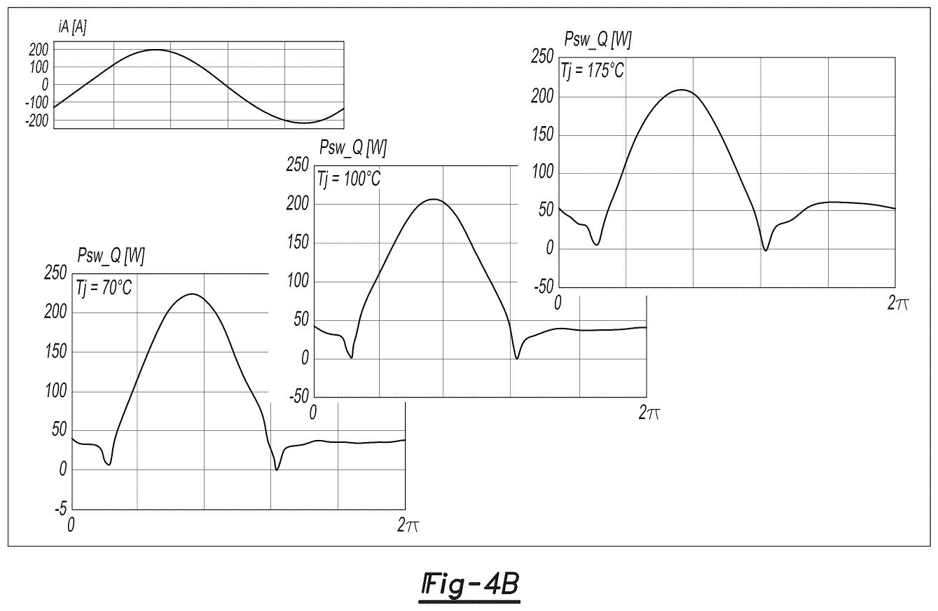

As shown in FIG. 2, this disclosure proposes a junction temperature estimation method suitable for motor operation at low speeds, including down to zero speed as implemented by controller 21. The method monitors each power device's temperature using three instantaneous phase currents ia, ib, ic. The estimated junction temperature of the six power devices is denoted as Tj[1-6], while Tdbc represents the direct bonded copper (DBC) temperature, which is measured using a DBC temperature sensor 22 installed near a SiC MOSFET die 24 that implements one of the power devices Qn on a DBC substrate 26, as shown in FIG. 3. Conduction loss map 28 and switching loss map 30 of FIG. 2 serve as computational models derived from an inverter circuit-based loss model and experimental data obtained through single-pulse and double-pulse tests. Their waveforms are shown in FIGS. 4A and 4B, respectively. These maps take several inputs, including the instantaneous phase currents, DC bus voltage Vdc, switching frequency fsw, modulation index MI, and the junction temperatures Tj[1-6]. The switching loss map 30 outputs the switching losses PLSW[1-6] of the six power devices, while the conduction loss map 28 provides the conduction losses PLC[1-6]. The total power loss PL[1-6] is obtained by summing the switching and conduction losses for each power device as PL[1-6]=PLC[1-6]+PLSW[1-6]. This total power loss is then used to determine the junction temperature rise ΔT[1-6] through a look-up table (LUT) 32. The LUT 32 is built from thermal test data and models the relationship between the DBC temperature, coolant temperature Tcool, and power loss. The output from the LUT 32 is then added to the measured DBC temperature to compute the estimated junction temperature Tj[1-6] for each power device as Tj[1-6]=Tdbc+ΔT[1-6], where ΔT[1-6] represents the temperature difference between the junction and the DBC temperature sensor, which depends on power loss and coolant temperature.

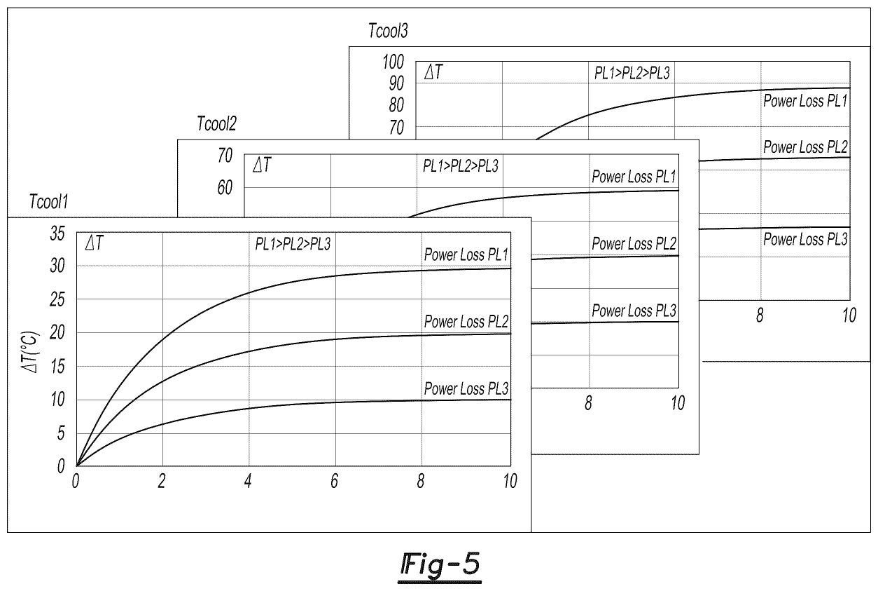

The DBC temperature sensor 22 should be positioned as close as possible to the SiC chip 24, ensuring direct contact with the top of the DBC layer 26 while maintaining insulation requirements. Various types of temperature sensors can be used. The switching loss map 30 and conduction loss map 28 are models developed from experimental test data and inverter circuit-based loss calculations. These models enable the estimation of power losses under different operating conditions. As shown in FIG. 2, the switching loss PLSW[1-6] represents the losses occurring during power device switching events, while the conduction loss PLC[1-6] corresponds to the losses that occur when the device is conducting current. These losses depend on the instantaneous phase currents, DC bus voltage, switching frequency, junction temperature, and MI. From FIG. 2, the junction temperature estimation follows the equation Tj=Tdbc+ΔTj−dbc, where ΔTj−dbc is the junction-to-DBC temperature difference, which is a function of power loss and coolant temperature as shown in FIG. 5.

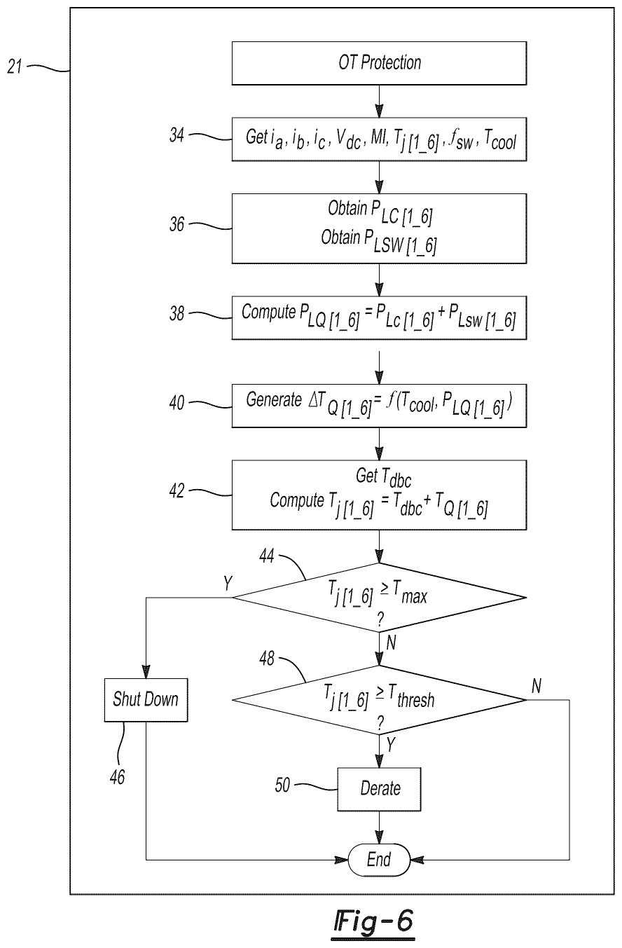

FIG. 6 presents an algorithm that is designed to provide over-temperature protection based on real-time junction temperature estimation. The protection mechanism activates under the following conditions: if the estimated junction temperature Tj[1-6] exceeds the predefined threshold temperature Tthresh, a derating action is activated, reducing the phase current. If Tj[1-6] exceeds the maximum allowable temperature Tmax, the power converter is shut down to prevent thermal issues. The predefined temperature limits in this example are Tthresh=150 °C or a user-defined value, and Tmax=175 °C or a user-defined value.

In a first operation 34, the system acquires the instantaneous phase currents ia, ib, ic, DC bus voltage Vdc, modulation index MI, switching frequency fsw, initial junction temperatures Tj[1-6], and coolant temperature Tcool from a coolant temperature sensor. Next at operation 36, the conduction losses PLC[1-6] and switching losses PLSW[1-6] for all six power devices are computed. The total power loss PLQ[1-6] for each power device is then obtained by summing the conduction and switching losses as PLQ[1-6]=PLC[1-6]+PLSW[1-6] at operation 38. Using the LUT 32, the temperature rise ΔTQ[1-6] is determined at operation 40 based on coolant temperature and power loss. The DBC temperature Tdbc is obtained from the sensor, and the new junction temperature for each power device is computed as Tj[1-6]=Tdbc+ΔTQ[1-6] at operation 42.

The system then checks at operation 44 whether any junction temperature exceeds the maximum allowable temperature Tmax. If Tj[1-6]≥Tmax, the inverter is shut down to prevent thermal issues at operation 46. Otherwise, the process moves to operation 48, where the system determines whether a derating operation is required. If the junction temperature is within the predefined threshold range Tthresh≤Tj[1-6]<Tmax, the system activates derating control at operation 50, reducing the phase current to lower power losses and prevent excessive heating. If Tj[1-6]<Tthresh, no further action is needed, and the system waits for the next temperature update cycle.

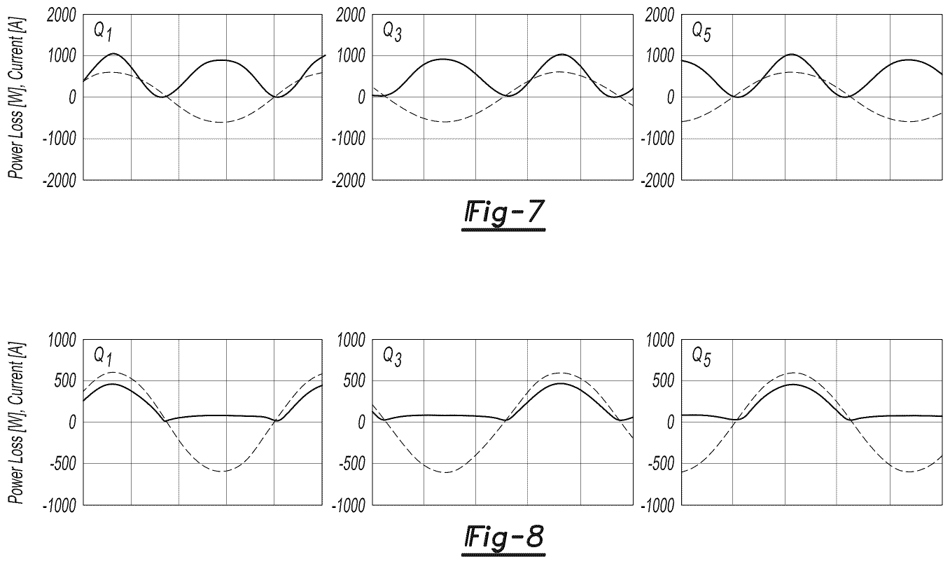

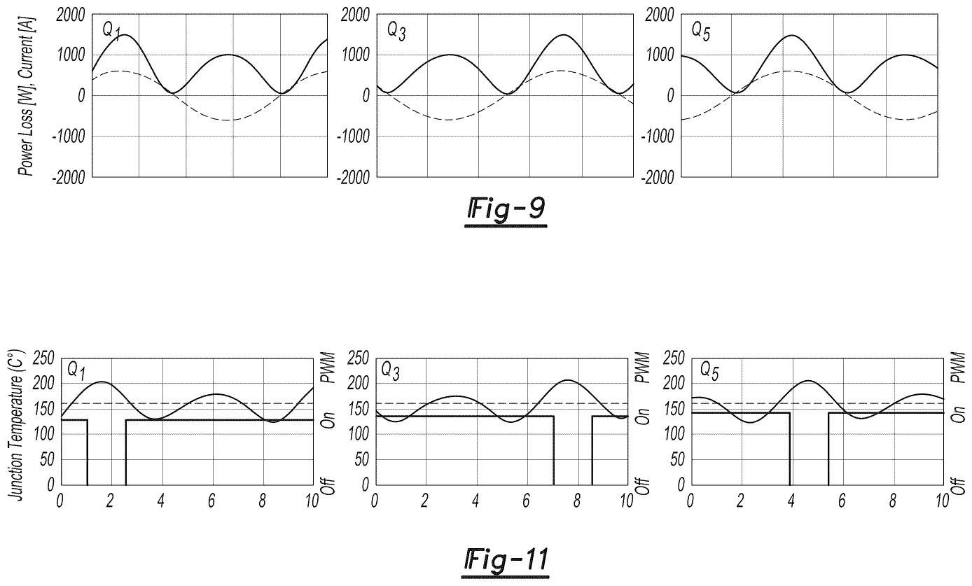

FIGS. 7 through 11 show simulation results. In the simulation, phase current is 424A RMS, DC bus voltage is 800 V, switching frequency is 10 kHz, modulation index is 0.86, coolant temp is 70 C, and flow rate is 3 LPM. FIGS. 7 through 9 show conduction loss, switching loss, and total loss of three of the six power switches, respectively.

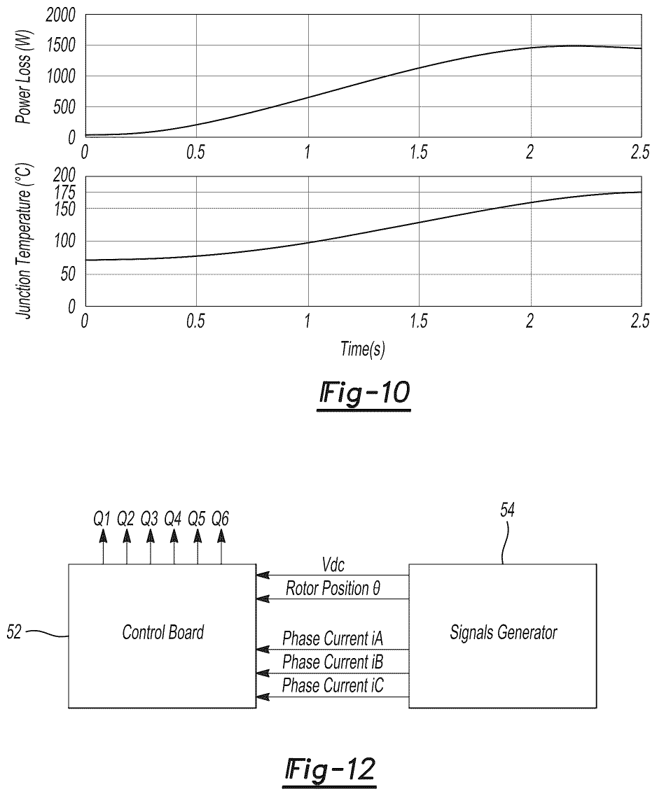

FIG. 10 shows the instantaneous power loss and temperature of the power device Q1 of phase a during a start-up operation. The temperature is not in steady state.

FIG. 11 illustrates the instantaneous junction temperatures of three of the six power switches, their average junction temperature during steady-state operation, and the state of PWM signals to an inverter. The data shows that the instantaneous junction temperature of individual power devices can exceed an example maximum allowable temperature of 180 °C for short periods, occasionally surpassing 200 °C. Under these conditions, the inverter is shut down to prevent thermal issues. However, because the average junction temperature remains below the maximum threshold, the traditional over-temperature protection method would not trigger a shutdown, allowing the power devices to continue operating even when their actual temperatures exceed 180 °C, and in some cases, 200 °C. With the proposed techniques, over-temperature shutdown protection is activated based on instantaneous junction temperature estimation.

Several evaluation strategies can be used to identify use in the field. A few examples include the following. With reference to FIGS. 1 and 12, a test setup can be established by first disconnecting the inverter AC outputs from the load 18 and disconnecting feedback signals of a control board 52 from their original circuits. In particular, disconnecting the high voltage DC voltage feedback Vdc from its sensing circuit, disconnecting the rotor position feedback θ from the rotor position sensor, and disconnecting the three phase current feedback ia, ib, ic from their current sensors. The test setup is completed by connecting the feedback signals of the control board 52 to a signal generator 54, in particular, the high voltage DC bus voltage signal Vdc, rotor position θ, and three phase currents ia, ib, ic are from the signal generator 54.

A low-speed operation test can be used to evaluate the system's over-temperature protection mechanism. First, a rotor position waveform θ is generated with a rotor speed of 1 Hz. Simultaneously, a signal corresponding to a normal high voltage DC bus voltage Vdc is generated. Next, three-phase currents ia, ib, ic are generated at a frequency of 1 Hz. The PWM signals for Q1-Q6 from the control board 52 are monitored to verify that the control board 52 is functioning correctly. The amplitude of the three-phase currents is gradually increased until the system's over-temperature protection is triggered, indicated by the shutdown of the PWM signals for Q1-Q6. At this point, the corresponding current amplitude is recorded and defined as the threshold current IOT for over-temperature protection.

Next is a high-speed operation test, where the rotor speed is increased to 200 Hz while maintaining the current amplitude at the previously defined threshold value IOT. Under these conditions, it is observed that over-temperature protection is not triggered, demonstrating that the protection mechanism behaves differently under high-speed operation.

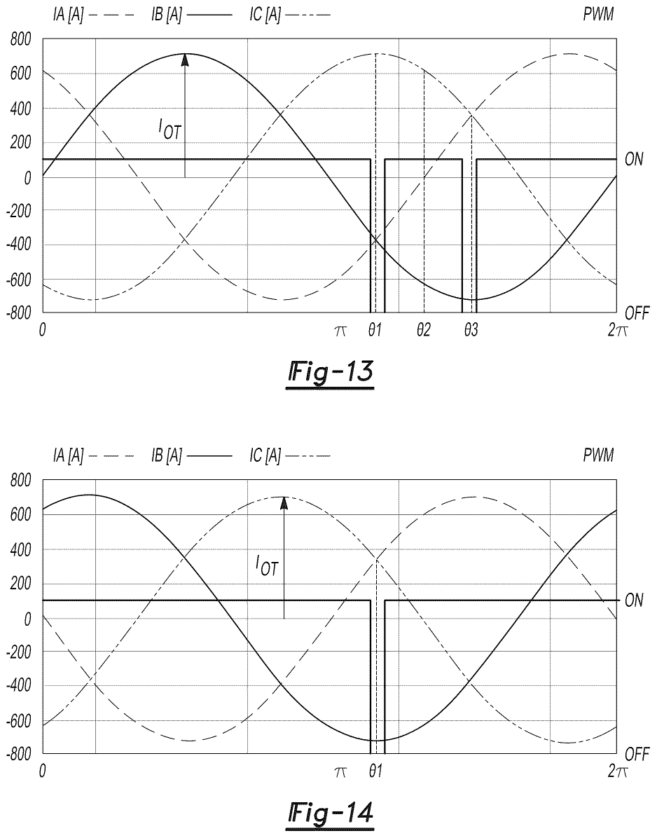

In a first angular domain operation test, the current amplitude is maintained at IOT as shown in FIG. 13, with the three-phase currents defined as ia=IOTsin(θ−θ2), ib=IOTsin(θ−θ2−2π/3), and ic=IOTsin(θ−θ2−4π/3). The rotor position θ is then varied while monitoring the PWM signals for Q1-Q6 from the control board 52. At rotor position θ1, the PWM signals are shut off due to over-temperature protection, indicating that overheating occurs in the top switch of phase C. At rotor position θ2, the PWM signals remain active, meaning that no over-temperature protection is triggered. However, at rotor position θ3, the PWM signals are again shut off, this time due to overheating in the lower switch of phase B.

In a second angular domain test, the current amplitude is maintained at IOT, and the rotor position is set to θ=θ1. The three-phase currents are adjusted to introduce a phase shift of π/3 radians, following the expressions ia=IOTsin(θ−θ2+π/3), ib=IOTsin(θ−θ2−π/3), and ic=IOTsin(θ−θ2−π). At the rotor position θ=θ1, the PWM signals for Q1-Q6 are shut off due to over-temperature protection, indicating that overheating occurs at the lower switch of phase B, as shown in FIG. 14. This observation demonstrates that after the current phase angle shifts by π/3 radians, the over-temperature condition transitions from the top switch of phase C to the lower switch of phase B at rotor position θ1.

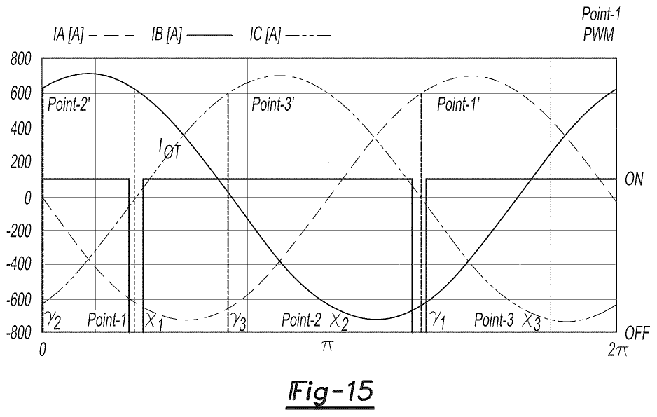

A third angular domain operation test evaluates three specific operating points as shown in FIG. 15. The first point is defined by the condition ia+ib=0, ic=0. The second point is given by ib+ic=0, ia=0, and the third point by ic+ia=0, ib=0.

For the first test condition at point 1, the procedure begins by setting ib>IOT while maintaining ia+ib=0 and ic=0. The rotor position is varied, and the PWM signals Q1-Q6 are monitored. It is observed that the PWM signals are shut off at position x1 due to over-temperature protection, with overheating occurring in the upper switch of phase B and the lower switch of phase A. If instead ia>IOT while still satisfying ia+ib=0 and ic=0, the test is repeated, revealing that the PWM signals shut off at position y1, where overheating affects the upper switch of phase A and the lower switch of phase B. The positions x1 and y1 are found to be separated by a 180° (or π) phase shift.

For the second test condition at point 2, the process is repeated under the condition ib+ic=0, ia=0. When ic>IOT, the rotor position is varied, and the PWM signals are monitored. The results show that the PWM signals shut off at position x2 due to over-temperature protection, with overheating occurring in the upper switch of phase C and the lower switch of phase B. If instead ib>IOT, the test is repeated, revealing that the PWM signals shut off at position y2, with overheating occurring in the upper switch of phase B and the lower switch of phase C. Similar to the first test condition, positions x2 and y2 exhibit a 180° (or π) phase difference.

For the third test condition at point 3, the same procedure is applied under the condition ic+ia=0, ib=0. When ia>IOT, the rotor position is adjusted, and the PWM signals are monitored. The results show that at position x3, the PWM signals shut off due to over-temperature protection, with overheating occurring in the upper switch of phase A and the lower switch of phase C. If ic>IOT, the test is repeated, showing that the PWM signals shut off at position y3, where overheating affects the upper switch of phase C and the lower switch of phase A. The positions x3 and y3 are also separated by a 180° (or π) phase shift.

Finally, it is observed that the positions x1, x2, and x3 exhibit a 120° (or 2π/3) angular shift relative to one another, while positions y1, y2, and y3 also follow a 120° (or 2π/3) angular separation pattern.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While example embodiments are described above, it is not intended that these embodiments describe all possible forms encompassed by the claims. The words used in the specification are words of description rather than limitation, and it is understood that various changes may be made without departing from the spirit and scope of the disclosure. The words controller and controllers may be interchanged herein.

What is claimed is:

1. A power electronics system comprising:
an electric machine;
a multi-phase inverter including a plurality of switches; and
a controller programmed to shut down the multi-phase inverter according to an instantaneous temperature of one of the switches when the electric machine is in rotor lock.

2. The power electronics system of claim 1, wherein the controller is further programmed to derate the multi-phase inverter according to the instantaneous temperature when the electric machine is in rotor lock.

3. The power electronics system of claim 1, wherein the controller is further programmed to shut down the multi-phase inverter at a rotor position that corresponds to peak or negative peak values of phase currents associated with the switches.

4. The power electronics system of claim 1, wherein the controller is further programmed to shut down the multi-phase inverter at a rotor position that corresponds to non-peak values of phase currents associated with the switches.

5. The power electronics system of claim 1, wherein chips implementing the switches lack temperature sensors.

6. The power electronic system of claim 5 further comprising a temperature sensor mounted adjacent to one of the switches.

7. A vehicle propulsion drive system comprising:
a traction battery;
an electric machine;
a power converter configured to transfer power between the traction battery and electric machine; and
a controller programmed to, during operation of the power converter at a constant multi-phase current, stop pulse width modulation commands to switches of the power converter at intervals of one electric revolution of a rotor of the electric machine that do not correspond with peak or negative peak values of the constant multi-phase current.

8. The vehicle propulsion drive system of claim 7, wherein the controller is further programmed to, during operation of the power converter at the constant multi-phase current, stop pulse width modulation commands to the switches at peak or negative peak values of the multi-phase current.

9. The vehicle propulsion drive system of claim 7, wherein the controller is further programmed to derate the power converter.

10. The vehicle propulsion drive system of claim 7, wherein chips implementing the switches lack temperature sensors.

11. The vehicle propulsion drive system of claim 10 further comprising a temperature sensor mounted adjacent to one of the switches.

12. The vehicle propulsion drive system of claim 7, wherein the constant multi-phase current is a constant 1 Hz multi-phase current.

13. An automotive control system comprising:
a controller programmed to, during operation of a multi-phase inverter at a constant multi-phase current, stop pulse width modulation commands to switches of the multi-phase inverter at peak or negative peak values of the constant multi-phase current.

14. The automotive control system of claim 13, wherein the controller is further programmed to, during operation of the multi-phase inverter at the constant multi-phase current, stop pulse width modulation commands to the switches at intervals of one electric revolution of a rotor of an electric machine that do not correspond with peak or negative peak values of the constant multi-phase current.

15. The automotive control system of claim 13, wherein the controller is further programmed to derate the multi-phase inverter.

16. The automotive control system of claim 13, wherein chips implementing the switches lack temperature sensors.

17. The automotive control system of claim 16 further comprising a temperature sensor mounted adjacent to one of the switches.

18. The automotive control system of claim 13, wherein the constant multi-phase current is a constant 1 Hz multi-phase current.
